(19) United States
(12) Patent Application Publication
(10) Pub. No.: US 2017/0187705 A1
(43) Pub. Date: Jun. 29, 2017

(54) METHOD OF CONTROLLING ACCESS TO BUSINESS CLOUD SERVICE

(71) Applicant: SOMANSA CO., LTD., Seoul (KR)

(72) Inventors: Je Hyun SHIM, Incheon (KR); Tae Wan KIM, Seoul (KR); Seung Tae PAEK, Seoul (KR)

(73) Assignee: SOMANSA CO., LTD.

(21) Appl. No.: 15/091,726

(22) Filed: Apr. 6, 2016

(30) Foreign Application Priority Data
Dec. 24, 2015 (KR) 10-2015-0185906

(51) Int. Cl. H04L 29/06

(52) U.S. Cl. CPC H04L 63/0815; H04L 63/10

(57) ABSTRACT

Disclosed herein is a method of controlling access to a business cloud service. The method includes transmitting, as a service server receives a bushiness cloud service access request from a terminal of a service user, a single sign on (SSO) authentication request for integrated authentication of access of the service user to at least one business cloud service to an authentication server, requesting, as the authentication server receives the SSO authentication request, the terminal for authentication information of the service user and generating an authentication response by comparing the authentication information received from the terminal with prestored authentication information, and determining, by a reverse proxy server, a denial or permission of the access of the service user to the business cloud service by comparing context information extracted from the SSO authentication request and the authentication response with a preset policy.

### CROSS-REFERENCE TO RELATED APPLICATION

This application claims the benefit of Korean Patent Application No. 2015-0185906, filed on Dec. 24, 2015 in the Korean Intellectual Property Office, the disclosure of which is incorporated herein by reference.

### FIELD

The present invention relates to a method of controlling access to a business cloud service, and more particularly, to a method of controlling access to a business cloud service, in which a single sign on (SSO) authentication process with respect to a user of the business cloud service is performed and then access of the user to the business cloud service is denied or permitted by comparing context information extracted from a request of the user for the business cloud service and a response with a preset policy.

### BACKGROUND

A cloud indicates that information technology (IT) infrastructures, that is, hardware, software, servers, enterprise resource planning (ERP), data, etc., which are collectively called as IT resources are provided in service forms standardized to a certain degree.

Services defined as the cloud have features in which IT services are used as a user want at anytime and anywhere through any device and costs thereof are paid according to the amount IT services used.

Such cloud computing has been developed as a form in which all the technologies of grid computing, utility computing, and software as a service (SaaS) are integrated to provide IT resources in a form of services.

That is, in a real cloud computing service (hereinafter, referred to as a cloud service), SaaS, platform as a service (PaaS), infrastructure as a service (IaaS), etc. are all included. Recently, mobile devices are coupled thereto and thus smart work is embodied in a cloud environment.

The cloud service described above has been vigorously introduced in enterprises. Enterprises tend to introduce various types of cloud services. Various types of cloud services have unique authentication methods, respectively. Accordingly, users may pass through a unique authentication process for each cloud service to use to access the corresponding cloud service.

However, when using various cloud services at the same time, hassles occur in authentication processes.

To reduce hassles in authentication processes described above, each cloud service provides a single sign on (SSO) function. It allows users to use many cloud services at the same time through only one authentication process.

However, since SSO is generally a method of simply authenticating only through identification and a password, it is difficult to control access to a cloud service, etc. which need to control user's access. Due to this, unintended information spill of enterprises may occur.

[Patent Document]

As a prior art document related to the present invention, there is Korean Patent Publication No. 10-2014-0124100 (published on Oct. 24, 2014).

### SUMMARY

It is an aspect of the present invention to provide a method of controlling access to a business cloud service, in which a single sign on (SSO) authentication process with respect to a user of the business cloud service is performed and then access of the user to the business cloud service is denied or permitted by comparing context information extracted from a request of the user for the business cloud service and a response with a preset policy.

Aspects of the present invention are not limited thereto and additional aspects of the invention will be obvious to one of ordinary skill in the art from the following description.

In accordance with one aspect of the present invention, a method of controlling access to a business cloud service includes transmitting, as a service server of a business cloud service provider receives a bushiness cloud service access request from a terminal of a service user, a single sign on (SSO) authentication request for integrated authentication of access of the service user to at least one business cloud service to an authentication server of an identification (ID) provider, requesting, as the authentication server receives the SSO authentication request, the terminal for authentication information of the service user and generating an authentication response by comparing the authentication information received from the terminal with prestored authentication information, and determining, by a reverse proxy server, a denial or permission of the access of the service user to the business cloud service by comparing context information extracted from the SSO authentication request and the authentication response with a preset policy.

The SSO authentication request may include an Internet protocol (IP) address of the terminal of the service user and information of a user agent installed in the terminal of the service user.

The authentication response may include a time when the SSO authentication request is issued, a title of an accessible business cloud service which the service user is able to access, identification of an account of the service user, and user attribute data.

The preset policy may include, for at least one user, a type of a business cloud service which a corresponding service user is able to access, a type of a business cloud service which the corresponding service user is unable to access, and a service access regulation which includes an accessible time of the business cloud service which the corresponding service user is able to access.

The SSO authentication request and the authentication response may be performed using a security assertion markup language (SAML) standard.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a configuration diagram of a business cloud service system which controls access to a business cloud service in accordance with one embodiment of the present invention;

FIG. 2 is a flowchart illustrating a method of controlling access to a business cloud service in accordance with one embodiment of the present invention; and

FIG. 3 is a detailed flowchart illustrating the method of controlling the access to the business cloud service in accordance with one embodiment of the present invention shown in FIG. 2.

### DETAILED DESCRIPTION

Hereinafter, exemplary embodiments of the present invention will be described in detail with reference to the attached drawings.

The embodiments of the present invention are provided to more completely explain the present invention to one of ordinary skill in the art. The following embodiments may be changed into various other forms, and the scope of the present invention will not be limited thereto. The embodiments are provided to allow the present disclosure to be more complete and to completely transfer the concept of the present invention to one of ordinary skill in the art.

The terms are used herein to describe particular embodiments but should not limit the present invention. As used herein, singular expressions, unless defined otherwise in contexts, include plural expressions. Also, it will be further understood that the terms “comprises” and/or “comprising” used herein specify the presence of stated shapes, numbers, operations, members, elements, and/or groups thereof, but do not preclude the presence or addition of one or more other shapes, numbers, operations, members, elements, and/or groups thereof. As used herein, the term “and/or” includes any and all combinations of one or more of the associated listed items.

It will be understood that although the terms “first”, “second”, etc. may be used herein to describe various members, components, areas, layers, and/or portions, these members, components, areas, layers and/or portions should not be limited by these terms. The terms do not mean a particular order, top and bottom, or merits and demerits but are used only to distinguish one member, area, or portion from others. Accordingly, a first member, area, or portion which will be described below may indicate a second member, area, or portion without deviating from teachings of the present invention.

Hereinafter, the embodiments of the present invention will be described with reference to schematic drawings thereof. Throughout the drawings, for example, according to manufacturing technologies and/or tolerances, modifications of illustrated shapes may be expected. Accordingly, the embodiments of the present invention should not be understood to be being limited to certain shapes of illustrated areas but will include changes in shape made while being manufactured.

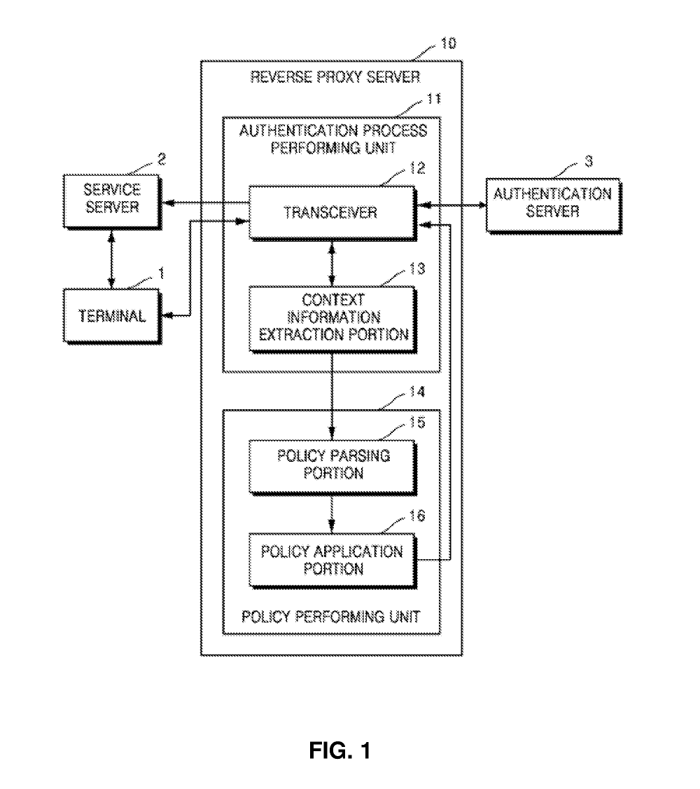

FIG. 1 is a configuration diagram of a business cloud service system which controls access to a business cloud service in accordance with one embodiment of the present invention.

Referring to FIG. 1, the business cloud service system in accordance with one embodiment of the present invention includes a terminal 1 of a service user, a service server 2 of a business cloud service provider, an authentication server 3 of an identification (ID) provider, and a reverse proxy server 10.

The terminal 1 of the service user is a terminal device which the service user has and may be a personal computer (PC), a mobile terminal, etc. The terminal 1 transmits a user's request for access to the business cloud service to the service server 2 of the business cloud service provider.

As the service server 2 receives the request for the access to the business cloud service received from the terminal 1, a single sign on (SSO) authentication request for integrated authentication of the service user for access to at least one business cloud service is transmitted to the authentication server 3 of the ID provider.

Here, the business cloud service provider, for example, may be one of Google Apps, Salesforce, Office 365, Box, Dropbox, AWS, etc. and indicates an agent that provides the business cloud service.

Also, SSO is a system of using many websites using only one ID, which is developed as it is necessary to integrally manage members of a large company or Internet-based enterprise which administrates many websites.

Also, the SSO authentication request of the service server 2 may be transmitted using a security assertion markup language (SAML) standard, and more particularly, may be redirect to the authentication server 3 of the ID provider while being included in an SAML request message.

In more detail, the SAML message may be transmitted to the reverse proxy server 10 through a browser of the terminal 1 and then may be transmitted from the reverse proxy server 10 to the authentication server 3.

SAML is an extensible mark-up language (XML) standard for exchanging business information over the Internet. It is a common language which allows mutual management of security services between different systems and is used to describe information in XML. Since transactions on the Web become widespread such as B2C, B2B, etc. and a start site and a completion site of a transaction is different, security information for allowing various transactions is necessary. Accordingly, an open solution which has mutual operability as a common language and compatibility with various protocols and an SSO function for easily accessing resources are provided.

The authentication server 3 of the ID provider is a system included in the ID provider which is an agent in charge of substantive authentication. The authentication server 3 has at least one piece of authentication information of the service user and provides a log-in page which includes an authentication information request to the terminal 1 of the service user as the SSO authentication request included in the SAML is received. After that, the authentication server 3 compares authentication information received from the terminal 1 of the service user with prestored authentication information and generates an authentication response.

Here, the received authentication information and the prestored authentication information include an ID and a password. That is, the authentication server 3 generates the authentication response by comparing the ID and password in the received authentication information with the ID and password in the prestored authentication information. The authentication response described above may be transmitted to the reverse proxy server 10 using the SAML standard, and more particularly, may be transmitted to the reverse proxy server 10 while being included in an SAML response message.

The reverse proxy server 10 is a reverse proxy server which operates using a servlet method. The reverse proxy server 10 mediates between the terminal 1 of the service user and the authentication server 3 of the ID provider and determines permission or denial of access of the service user to the business cloud service.

That is, the reverse proxy server 10 compares context information extracted from the SSO authentication request included in the SAML request message and the authentication response included in the SAML response message with a preset policy and determines the permission or denial of the access of the service user to the business cloud service.

As described above, when it is determined to deny the access of the service user to the business cloud service, the reverse proxy server 10 provides a denial page to the terminal 1 of the service user. On the contrary, when it is determined to permit the access of the service user to the business cloud service, the reverse proxy server 10 transmits the SAML response message to the service server 2 and then the service server 2 provides the business cloud service to the terminal 1 of the service user.

Here, the SSO authentication request may include an Internet protocol (IP) address of the terminal 1 of the service user and information of a user agent installed in the terminal 1 of the service user.

Also, the authentication response may include a time when the SSO authentication request is issued, a title of an accessible business cloud service which the service user can access, identification of an account of the service user, and user attribute data.

The reverse proxy server 10 includes an authentication process performing unit 11 and a policy performing unit 14.

The authentication process performing unit 11 includes a transceiver 12 and a context information extraction portion 13.

The transceiver 12 receives an SAML request message from the terminal 1 of the service user and transmits the SAML request message to the authentication server 3 using a reverse proxy servlet method. Also, the transceiver 12 receives an SAML response message from the authentication server 3 and transmits the SAML response message to the service server 2 when the policy performing unit 14 which will be described below determines to permit the access of the user to the business cloud service.

Here, the servlet indicates a small program executed by a server. Generally, a program which exists in a server to access a database according to a user input is executed using a common gateway interface (CGI) program. A java server program is executed using a java programming language. Since an execution rate is faster than that a CGI program and a program process is not generated, each user request is executed as one thread of a resident program (daemon). As an add-on module, the java servlet is executed at Netscape Enterprise Server, Internet information server (IIS), and Apache server.

The context information extraction portion 13 extracts the context information from the SSO authentication request included in the SAML request message and the authentication response included in the SAML response message. Here, the context information may include the IP address of the terminal 1 of the service user and the information of the user agent installed in the terminal 1 of the service user, included in the SSO authentication request, and the time when the SSO authentication request is issued, the title of the accessible business cloud service which the service user can access, the ID of the account of the service user, and the user attribute data, included in the authentication response.

In FIG. 1, the policy performing unit 14 includes a policy parsing portion 15 and a policy application portion 16.

The policy parsing portion 15 loads and parses a policy (file) of a preset XML form and stores, for at least one user, a type of a business cloud service which a corresponding service user can access, a type of a business cloud service which the corresponding service user cannot access, and a service access regulation which includes an accessible time of the business cloud service which the corresponding service user can access.

Here, the preset policy includes, for at least one user, the type of the business cloud service which the corresponding service user can access, the type of the business cloud service which the corresponding service user cannot access, and the service access regulation which includes the accessible time of the business cloud service which the corresponding service user can access.

Also, the preset policy file of the preset XML form may be loaded by an external device or may be loaded while being stored in a memory device (not shown) included in the policy parsing portion 15. The policy file described above may be periodically or aperiodically performed.

The policy application portion 16 compares the preset policy with the context information extracted from the context information extraction portion 13. When the extracted context information accords with the preset policy, the permission of the access of the service user to the business cloud service is determined and notified to the transceiver 12. Accordingly, the transceiver 12 transmits the SAML response message received from the authentication server 3 to the service server 2.

Meanwhile, when the extracted context information does not accord with the preset policy, the policy application portion 16 determines the denial of the access of the service user to the business cloud service and notifies it to the transceiver 12. Accordingly, the transceiver 12 provides a preset denial page to the terminal 1 of the service user.

Here, the policy application portion 16 may check whether the title of the accessible business cloud service which the service user can access, included in the extracted context information, corresponds to the type of the accessible business cloud service which the service user can access, included in the service access regulation of the preset policy. In case of corresponding, it is checked whether the time when the SSO authentication request is issued, included in the extracted context information, accords with the accessible time of the accessible business cloud service which the service user can access, included in the service access regulation of the preset policy. In case of accordance, the permission of the access of the service user to the business cloud service may be determined. In case of discord, the denial of the access of the service user to the business cloud service may be determined.

The determination of the policy application portion 16 with respect to the permission or denial of the access of the service user to the business cloud service is merely an example but is not limited thereto.

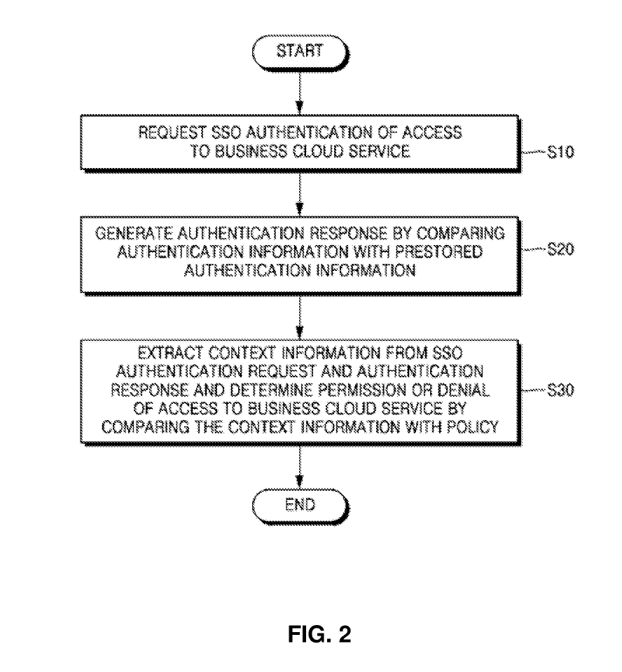

FIG. 2 is a flowchart illustrating a method of controlling access to a business cloud service in accordance with one embodiment of the present invention.

The method of controlling the access to the business cloud service shown in FIG. 2 may be performed by the components of the business cloud service system shown in FIG. 1 but is not limited thereto.

The service server 2 of the business cloud service provider, according to a business cloud service access request from the terminal of the service user, transmits an SSO authentication request for integrated authentication of access of the service user to at least one business cloud service to the authentication server 3 of the ID provider (S10). Here, the SSO authentication request may include an Internet protocol (IP) address of the terminal 1 of the service user and information of a user agent installed in the terminal 1 of the service user. The SSO authentication request may be transmitted while being included in an SAML request message.

As receiving the SSO authentication request, the authentication server 3 requests the terminal 1 of the service user for authentication information of the service user and generates an authentication response by comparing received authentication information with preset authentication information (S20). Here, the authentication response may include a time when the SSO authentication request is issued, a title of an accessible business cloud service which the service user can access, identification of an account of the service user, and user attribute data. The authentication response may be transmitted while being included in an SAML response message.

The reverse proxy server 10 compares context information extracted from the SSO authentication request and the authentication response with preset policy and determines a denial or permission of the access of the service user to the business cloud service (S30).

Here, the preset policy includes, for at least one user, a type of a business cloud service which a corresponding service user can access, a type of a business cloud service which the corresponding service user cannot access, and a service access regulation which includes an accessible time of the business cloud service which the corresponding service user can access.

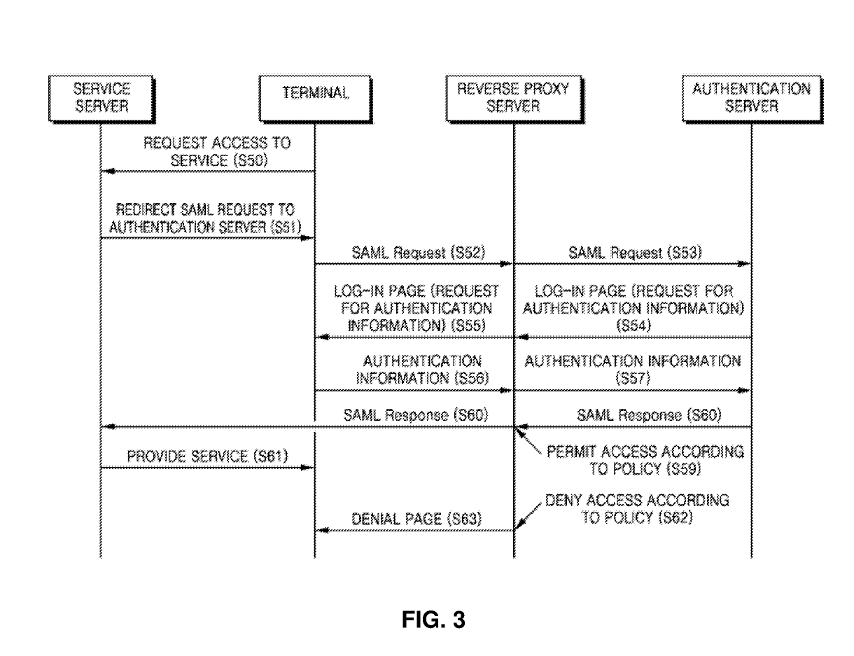

FIG. 3 is a detailed flowchart illustrating the method of controlling the access to the business cloud service in accordance with one embodiment of the present invention shown in FIG. 2.

Referring to FIG. 3, the terminal 1 of the service user receives a business cloud service access request of the service user and transmits it to the service server 2 of the business cloud service provider (S50).

The service server 2, as receiving the business cloud service access request from the terminal 1 of the service user, allows the SSO authentication request for the integrated authentication of the access of the service user to the at least one business cloud service to be included in the SAML request message and to be transmitted to the terminal 1 to be redirected to the authentication server 3 of the ID provider (S51).

The terminal 1 transmits the SAML request message to the reverse proxy server 10 (S52), and then the reverse proxy server 10 transmits the SAML request message to the authentication server 3 (S53).

The authentication server 3, as receiving the SAML request message which includes the SSO authentication request, transmits a log-in page for requesting the authentication information of the service user to the terminal 1 via the reverse proxy server 10 (S54 and S55).

With respect thereto, when the service user inputs authentication information to the terminal 1, the terminal 1 transmits the input authentication information to the authentication server 3 via the reverse proxy server 10 (S56 and S57).

The authentication server 3 generates an authentication response by comparing the authentication information received from the terminal 1 with the preset authentication information and transmits the authentication response to the reverse proxy server 10 while the authentication response is included in the SAML response message (S58).

The reverse proxy server 10 compares the context information extracted from the SSO authentication request included in the SAML request message and the authentication response included in the SAML response message with the preset policy.

As a result of comparison, when the extracted context information accords with the preset policy, the reverse proxy server 10 determines the permission of the access of the service user to the business cloud service (S59) and transmits the SAML response message received from the authentication server 3 to the service server 2 (S60). Accordingly, the service server 2 provides the business cloud service to the terminal 1 of the service user (S61).

Meanwhile, when the extracted context information does not accord with the preset policy, the reverse proxy server 10 determines the denial of the access of the service user to the business cloud service (S62) and outputs a preset denial page to the terminal 1 of the service user (S63).

As is apparent from the above description, in a method of controlling access to a business cloud service, a single sign on (SSO) authentication process with respect to a user of the business cloud service is performed and then access of the user to the business cloud service is denied or permitted by comparing context information extracted from a request of the user for the business cloud service and a response with a preset policy, thereby definitely controlling access to a cloud service, etc. which need control user's access to prevent unintended information spill of enterprises.

While the present invention has been particularly shown and described with reference to exemplary embodiments thereof, it will be understood by those of ordinary skill in the art that various changes in form and details may be made therein without departing from the spirit and scope of the present invention as defined by the following claims. Therefore the embodiments described above should be descriptively considered not in a limitative viewpoint. Accordingly, the scope of the present invention will not be limited to the embodiments described above and it should be understood to include the content disclosed in the claims and equivalents thereof.

What is claimed is:

1. A method of controlling access to a business cloud service, comprising:
transmitting, as a service server of a business cloud service provider receives a bushiness cloud service access request from a terminal of a service user, a single sign on (SSO) authentication request for integrated authentication of access of the service user to at least one business cloud service to an authentication server of an identification (ID) provider;
requesting, as the authentication server receives the SSO authentication request, the terminal for authentication information of the service user and generating an authentication response by comparing the authentication information received from the terminal with prestored authentication information; and
determining, by a reverse proxy server, a denial or permission of the access of the service user to the business cloud service by comparing context information extracted from the SSO authentication request and the authentication response with a preset policy.

2. The method of claim 1, wherein the SSO authentication request comprises an Internet protocol (IP) address of the terminal of the service user and information of a user agent installed in the terminal of the service user.

3. The method of claim 1, wherein the authentication response comprises a time when the SSO authentication request is issued, a title of an accessible business cloud service which the service user is able to access, identification of an account of the service user, and user attribute data.

4. The method of claim 1, wherein the preset policy comprises, for at least one user, a type of a business cloud service which a corresponding service user is able to access, a type of a business cloud service which the corresponding service user is unable to access, and a service access regulation which includes an accessible time of the business cloud service which the corresponding service user is able to access.

5. The method of claim 1, wherein the SSO authentication request and the authentication response are performed using security assertion markup language (SAML) standard.
